(19) United States
(12) Patent Application Publication
(10) Pub. No.: US 2025/0362816 A1
(43) Pub. Date: Nov. 27, 2025

(54) METHOD OF MEMORY ACCESS WITH EFFICIENT TAG PIPELINE LATENCY

(71) Applicant: Arm Limited, Cambridge (GB)

(72) Inventors: Edward Martin McCombs, JR., Austin, TX (US); Andrew David Tune, Dronfield (GB); Sean James Salisbury, Dendron (GB); Akshay Kumar, New Delhi (IN)

(21) Appl. No.: 18/673,678

(22) Filed: May 24, 2024

(51) Int. Cl. G06F 3/06

(52) U.S. Cl. CPC G06F 3/0625; G06F 3/0659; G06F 3/0673

(57) ABSTRACT

A method of memory access includes, in a first stage, accessing a preamble tag memory and performing a comparison between received preamble bits of an address for lookup and preamble bits stored in the preamble tag memory to generate a partial hit; and, in a second stage, for any partial hits on the preamble bits, accessing a prologue tag memory storing prologue bits corresponding to a second set of bits of the tags to which the preamble bits generated the partial hit in the first stage and performing a corresponding comparison between received prologue bits of the address for lookup and the prologue bits stored in the prologue tag memory to finalize a hit.

### BACKGROUND

Cache memory and other memory subsystems can be located relatively close to a processor to provide fast access of frequently used data to the processor. Random Access Memory (RAM), and specifically Static Random Access Memory (SRAM), is typically the type of memory used for these memory subsystems. SRAM is generally configured as an array, or matrix of memory units that are individually addressable.

Memory can be set-associative and organized by index and way. A cacheline refers to the data corresponding to a memory address. A set refers to a limited number of places in the memory where a cacheline can reside (e.g., if associativity is equal to 1, the memory is considered to be “direct mapped”). Each associativity corresponds to a “way.” For example, an associativity of 2 corresponds to two ways, an associativity of 4 corresponds to four ways, and an associativity of 16 corresponds to 16 ways. The index indicates which set a cacheline is stored or is to be stored into and is computed from the address. A tag refers to part of the address that is stored in the tag RAM and identifies, in conjunction with the index, the memory address that the cacheline corresponds with.

To find whether a memory address is in the cache memory or other memory subsystem, a lookup operation can be performed in the tag RAMs. As part of the lookup operation, a portion of an incoming address (e.g., the portion providing the tag function) is compared to the stored tags in the tag RAMs. A “hit” occurs when the incoming address (e.g., the portion providing the tag function) matches a stored tag in a way and the stored tag is considered valid (e.g., as per appropriate state bits(s)). In a typical n-way set-associative cache, data belonging to an address will be in 0 or 1 of n places. Based on the hit of the incoming tag portion with a tag in the tag RAM, the appropriate data RAM can be accessed. For a typical way-halting cache there is an attempt to reduce the number of bits of the tags that are accessed in each way. Thus, if there is any partial mismatch during the lookup (a “miss”), accesses to that way are halted, saving power by not accessing the full tag address lookup.

Accessing memory, such as RAM, utilizes large amounts of energy when multiple ways are accessed all at once using an incoming address to find a matching address that may be in one way of the memory. A process that can locate the desired tag while accessing a minimal number of ways has the potential to save a substantial amount of energy.

### BRIEF SUMMARY

Way-halting tag pipeline approaches are described. A tag pipeline refers to the logical order of operations performed during the process of memory access. Each stage in the tag pipeline includes the operations occurring in a single clock cycle. The latency of the tag pipeline is based on the time it takes to complete the longest operation for a stage in the tag pipeline and the number of stages in the pipeline. As described herein, a tag way halting process can be performed in two phases with corresponding stages as part of the tag pipeline.

A method of memory access in accordance with various implementations of the described way-halting tag pipeline approaches can include: in a first stage, accessing a preamble tag memory and performing a comparison between received preamble bits of an address for lookup and preamble bits stored in the preamble tag memory to generate a partial hit, wherein the preamble tag memory is a memory for storing preamble bits of tags; and in a second stage, for any partial hits on the preamble bits, accessing one or more prologue tag memories storing prologue bits corresponding to a second set of bits of the tags to which the preambles generated the partial hit in the first stage and performing a corresponding comparison between received prologue bits of the address for lookup and the prologue bits stored in the prologue tag memory to finalize a hit.

A system that may implement a way-halting tag pipeline as described herein can include: a memory subsystem including a preamble tag memory and one or more prologue tag memories. The preamble tag memory stores preamble bits of tags. The one or more prologue tag memories store prologue bits corresponding to a second set of bits of the tags and memory data information. The preamble tag memory and the one or more prologue tag memories each include a control circuit, wordline driver, and input/output circuitry. In the system, access to the one or more prologue tag memories is based on a partial hit of a received address on preamble bits stored in the preamble tag memory.

Advantageously, through the described approach, not only is it possible to determine that there is no hit in the first cycle, thereby reducing power consumption and improving speed, it is further possible to obtain a hit for a way in fewer cycles than in a conventional pipeline. Even when a same number of cycles are used as compared to a conventional pipeline, the amount of time/operational frequency for the clock can be reduced as compared to the conventional pipeline.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1A shows a simplistic representation of a lookup operation for a memory access in an n-way cache.

FIG. 1B illustrates a conventional approach for a tag pipeline.

FIG. 2A shows a simplistic representation of a proposed two-phase access utilizing a memory architecture as described herein.

FIG. 2B shows a simplistic pipeline of the two-phase access.

FIG. 3A and 3B illustrate example memory subsystems for comparison.

FIG. 4 illustrates a tag pipeline for a two-phase access as described herein.

FIGS. 5A and 5B illustrate tag pipelines for a two-phase access as described herein when implemented using a memory incorporating hit logic.

FIGS. 6A and 6B illustrate tag pipelines for a two-phase access as described herein when implemented using a memory incorporating hit logic and part of an error correction code circuitry.

FIG. 7A illustrates a representational diagram of memory circuitry that can be used in a first stage of tag way-halting as described herein.

FIG. 7B illustrates a representational diagram of memory circuitry that can be used in a second stage of tag way-halting as described herein.

FIG. 8A illustrates an example of data that may be stored in a preamble tag memory.

FIG. 8B illustrates an example of data that may be stored in a prologue tag memory.

### DETAILED DESCRIPTION

Way-halting tag pipeline approaches are described. A tag pipeline refers to the logical order of operations performed during the process of memory access. Each stage in the tag pipeline includes the operations occurring in a single clock cycle. The latency of the tag pipeline is based on the time it takes to complete the longest operation for a stage in the tag pipeline (related to the clock frequency) and the number of stages in the pipeline.

As described herein, a tag way halting process can be performed in two phases with corresponding stages as part of the tag pipeline. In the tag way halting process described, a first part of a tag lookup is used to filter accesses to ways containing bits for a second part of the tag lookup by inhibiting access to memory storing the ways that mismatch. The first part of the tag lookup uses a first set of bits of the tag and can be referred to as “preamble bits” or “preamble”. The second part of the tag lookup uses a second set of bits of the tag and can be referred to as “prologue bits” or “prologue.”

Current way halting techniques and configurations can suffer from high energy consumption and area overhead due to duplication of efforts across many ways (e.g., as part of additional circuitry and parallel operations) and can suffer delay penalties due to routing hit signals across a chip to different banks and memories. In addition, the power consumption due to parallel accesses of multiple memories can be an issue. Current way halting techniques are frequency limiting by looking up the preamble and prologue in the same access cycle. This creates a long cycletime and makes it unusable in modern designs.

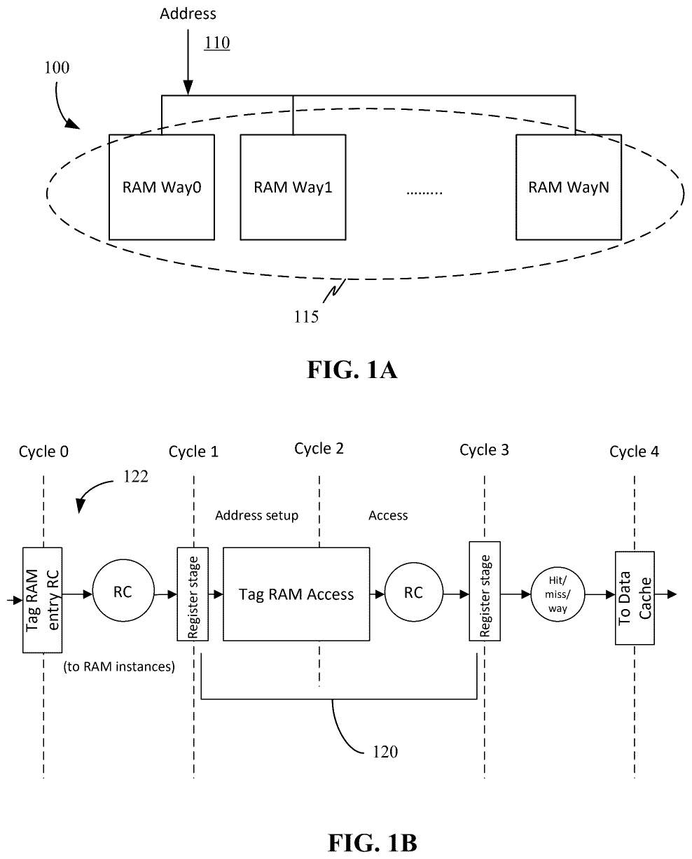

FIG. 1A shows a simplistic representation of a lookup operation for a memory access in an n-way cache. FIG. 1B illustrates a conventional approach for a tag pipeline.

Referring to FIG. 1A, during a lookup operation for a memory access in an n-way cache 100, an address 110 comes into the cache and goes out to the tag RAMs 115 storing all n ways (e.g., RAM Way0, RAM Way1, . . . , RAM WayN) of the n-way cache 100.

Referring to FIG. 1B, conventionally, tag way-halting is performed in a single memory access 120, where the tag RAMs 115 are accessed and the information read out (e.g., with a first clock cycle for address setup and a second clock cycle for access/readout) for a subsequent stage for applying hit/miss logic.

Accessing all n ways to compare tags requires the precharging and access operations for the memories storing all n ways (e.g., tag RAMs 115) and therefore consumes a significant amount of power. In addition, bits read from and written to these ways incur the delay to the furthest tag RAM every time when performing various conventional tag way halting approaches, which can contribute to delay penalties. For example, with reference to FIG. 1B, when the cache is of a certain size (e.g., such as found in a number of current system level caches), a Tag RAM entry delay stage 122 is included to provide sufficient time to access the tag RAMs farthest from the control logic of the n-way cache. The amount of wire delay can depend on the number and area/footprint of the way RAMs 115 as well as distance from the logic. For example, system level cache (or “last-level” cache) is useful in system-on-chip designs and is located between processor core(s) and main memory, which can result in a larger distance between the core and the cache (as compared to the distance between the core and the L1, L2, and L3 caches). Tags that are close in proximity to one another are able to omit the Tag RAM entry delay stage, but the large capacity in modern compute lends itself to inclusion of the tag RAM entry delay stage.

To address these potential energy inefficiencies and latencies, a technique involving sequential accesses while combining certain operations for tag way halting is presented.

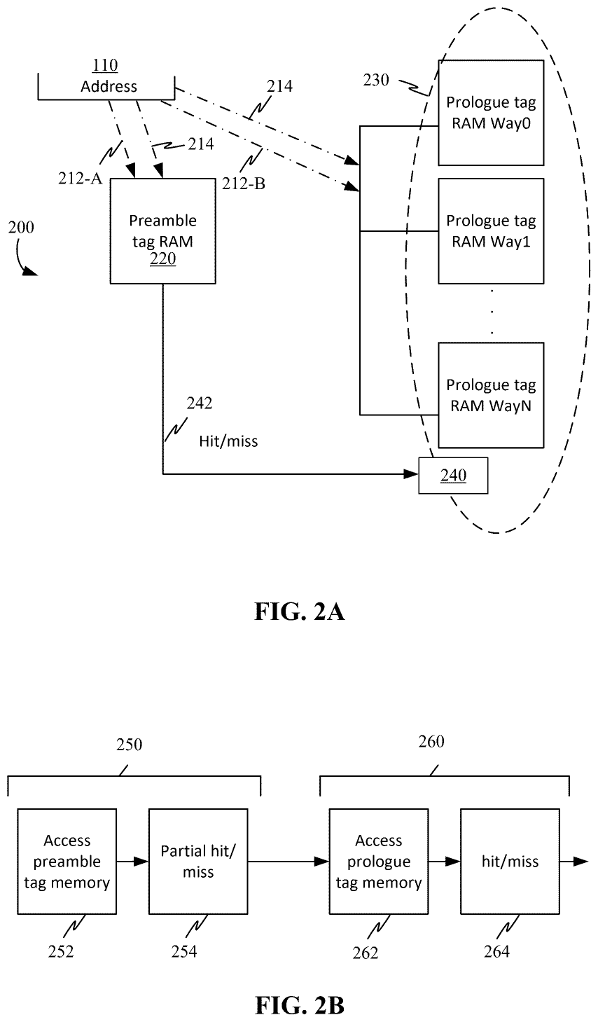

FIG. 2A shows a simplistic representation of a proposed two-phase access utilizing a memory architecture as described herein; and FIG. 2B shows a simplistic pipeline of the two-phase access.

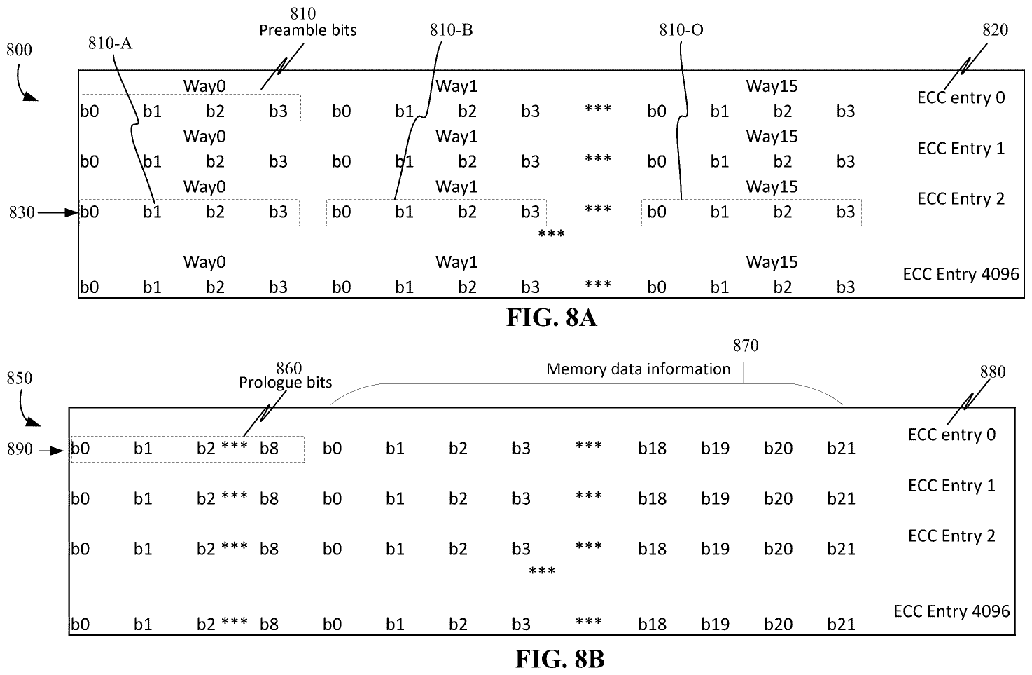

Referring to FIG. 2A, an n-way cache 200 of a proposed memory architecture can include one or more preamble tag memories 220 and one or more prologue tag memories 230 for each preamble tag memory 220 (where n is an integer greater than or equal to 1). Cache 200 can be a system level cache or one of the lower-level caches (e.g., L3 cache) or other memory subsystem, as examples. The preamble tag memory 220 stores preamble bits of tags. An example of the data stored in the preamble tag memory is shown in FIG. 8A. The one or more prologue tag memories 230 store prologue bits of the tags corresponding to a second set of bits of the tags stored in the preamble tag memory 220. An example of the data stored in a prologue tag memory is shown in FIG. 8B. The preamble tag memory 220 and the one or more prologue tag memories 230 each include a memory array, a control circuit, wordline driver, and input/output circuitry. A two-phase access is enabled by using the preamble tag memory 220 to control access to the one or more prologue tag memories 230. That is, access to the one or more prologue tag memories 230 is based on a partial hit of a received address on preamble bits stored in the preamble tag memory 220.

In operation, with reference to FIG. 2B, in a first stage 250, the preamble tag memory 220 is accessed (252) and a partial hit/miss operation is performed (254) by performing a comparison between received preamble bits of an address for lookup and preamble bits stored in the preamble tag memory 220 to generate a partial hit 242. Then, in a second stage 260, for any partial hits 242 on the received preamble bits, a prologue tag memory (e.g., of the one or more prologue tag memories 230) storing prologue bits corresponding to the second set of bits of the tags to which the preambles generated the partial hit in the first stage is accessed (262) and a corresponding hit/miss operation is performed (264) by performing a comparison between received prologue bits of the address for lookup and the prologue bits stored in the prologue tag memory 230 to finalize a hit. Not shown in FIG. 2B is the additional stage/clock cycle for each address setup (e.g., before access operations 252 and 262).

Accordingly, with reference to FIG. 2A, when an address 110 is received for lookup, the preamble 212-A of the tag portion of the address 110 and index bits 214 of the address 110 are used at the preamble tag memory 220 in the first stage 250. Then, for each hit of the preamble bits, a corresponding way with stored prologue bits of the tag(s) of those preamble bits that hit in the first stage 250 is accessed (e.g., as enabled by selection logic 240 coupled to the prologue tag memories 230 that enables access to each of the prologue tag memories 230 under control of a hit or miss signal(s)/partial hit(s) 242 output from the preamble tag memory 220). The prologue 212-B of the tag portion of the address 110 and the index bits 214 of the address 110 are used at the corresponding prologue tag memories 230 in the second stage 260. In that manner, only the ways that correspond to the partial hit from the preamble tag memory 220 are accessed in the prologue tag memory 230 and the prologue 212-B is used to determine a fully complete, combined hit or miss for the address 110.

In some cases, the preamble tag memory 220 stores preamble bits of a plurality of ways and each prologue tag memory of the one or more prologue tag memories 230 stores associated prologue bits of one or more of the plurality of ways (see e.g., FIGS. 8A-8B). Following the described pipeline, all the prologue tag memories 230 storing the prologue bits corresponding to the tags to which the preambles generated the partial hit in the first stage are accessed in the second stage. Thus, the finalizing of a hit or miss can be performed in parallel when there are multiple ways that indicate a partial hit.

It should be understood that while n prologue tag memories are shown for n ways for illustrative purposes, more than one way may be combined in a same memory. For example, two or more ways may be combined into one RAM. In addition, in some cases, more than one preamble tag RAM is provided in order to be able to store the preambles of all the ways. Indeed, in some cases, a cache or other memory subsystem includes multiple preamble tag memories and corresponding one or more prologue tag memories.

By placement of the preamble tag memory physically closer to control logic of the cache or other memory subsystem, it is possible to increase speed and provide further power savings from the interconnecting wires (e.g., avoiding latency and reducing power consumption). This allows for omission of the RAM entry delay stage 122 shown in FIG. 1B.

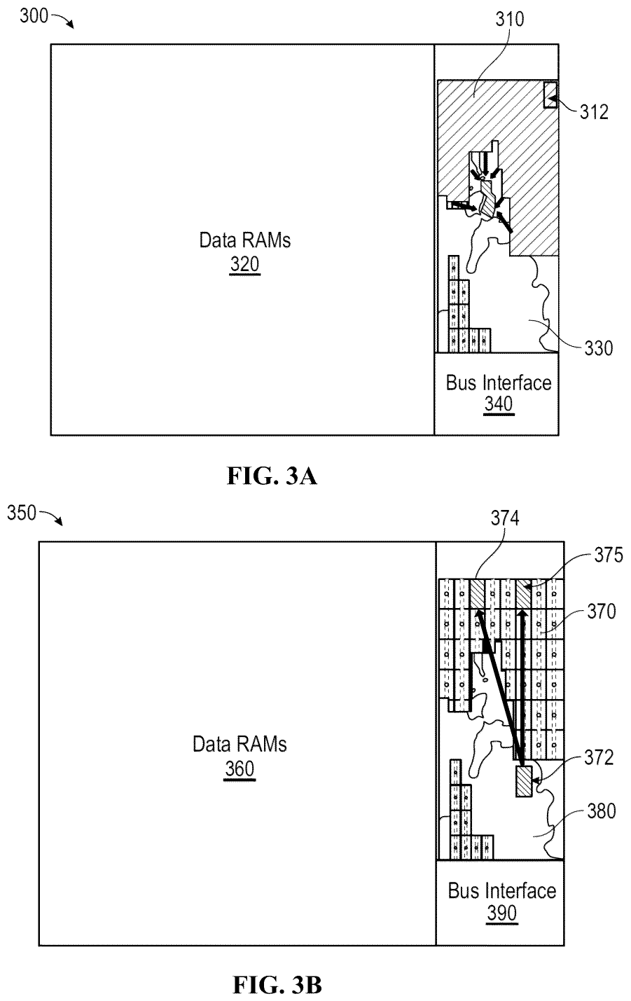

FIG. 3A and 3B illustrate example memory subsystems for comparison. Referring to FIG. 3A, memory subsystem 300 of a system on a chip (SoC) includes tag RAMs 310, data RAMs 320, and control logic 330. Data comes into the memory subsystem 300 through the bus interface 340. Following the tag pipeline described in FIG. 1B, a tag lookup in the tag RAMs 310 involves accessing all the ways so that every access may require sending signals to the farthest way (e.g., way RAM 312) over the interconnecting wires, resulting in significant power consumption.

Referring to FIG. 3B, memory subsystem 350 of a SoC includes data RAMs 360, a set of RAMs for use in lookup (e.g., tag RAMs 370), and control logic 380. Here, tag RAMs 370 are configured according to the memory architecture described herein with at least one preamble tag RAM 372 and a plurality of prologue tag RAMs. As illustrated by the figure, when data comes into the memory subsystem 350 through the bus interface 390 and applied by the control logic 380, a preamble tag RAM 372 is accessed first and only the ways that have a partial hit during the first stage are accessed in the second stage. For example, a first prologue tag RAM 374 and a second prologue tag RAM 375 containing prologue bits of the tags of ways that hit in the first stage are accessed.

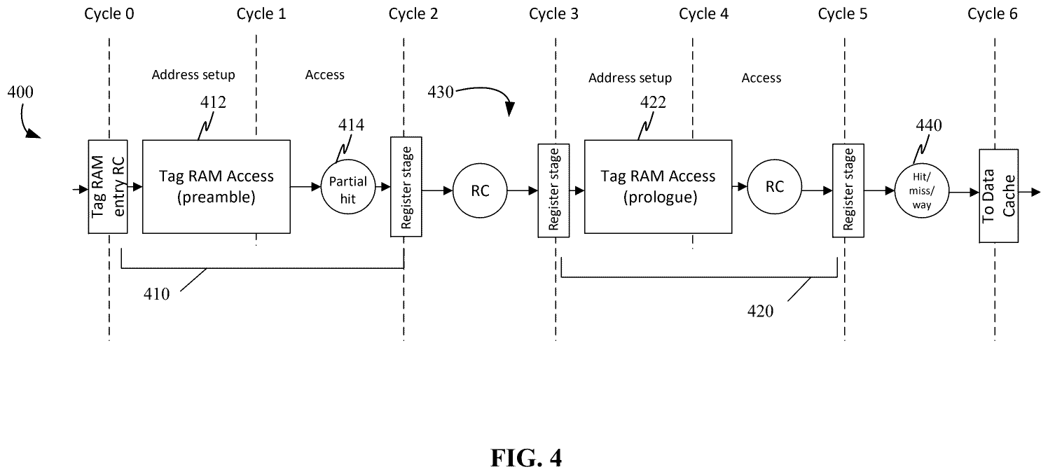

FIG. 4 illustrates a tag pipeline for a two-phase access as described herein. Referring to FIG. 4, a tag pipeline 400 for a two-phase access includes one RAM stage 410 (which may include an address setup stage and an access stage) for accessing the tag RAM (412) storing the preambles of a plurality of ways and another RAM stage 420 (which may also include an address setup stage and an access stage) for accessing the tag RAM(s) (422) storing the prologue (and other bits) of the ways that hit the preamble bits (e.g., as indicated by partial hit operations 414). The prologue bits from the ways that hit during the first RAM stage 410 are used to continue determining a hit or miss (e.g., hit/miss/way operation 440). Between stages, data may be held for a time sufficient for the bits to settle before the next stage. As can be seen, the RAM stage 410 (which includes the clock cycle inside the RAM) begins without the need for a delay stage for sending signals to the farthest tag RAMs.

The illustrated pipeline illustrates the two-phase access approach implemented using conventional RAM. In this case, an additional delay stage 430 is provided between the two RAM access stages to enable sufficient time for data to reach the farthest memories after the partial hit logic takes place. When using the conventional RAM, the data is read out from the RAM and may need to move across the wires to logic for performing the partial hit (414) and complete hit (440) determination.

Although the tag pipeline 400 using conventional RAMs is shown to require more cycles compared to that of a conventional pipeline such as shown in FIG. 1B (e.g., 6 cycles as compared to 4 cycles), the tag pipeline 400 enables certain efficiencies. For example, it is possible to determine that there is no hit by the second cycle. In addition, fewer tag RAMs are accessed due to the filtering effect of performing the partial hit, thereby reducing power consumption and improving latency. It is possible to determine that there is no hit in the first cycle because if there is no hit/match found by comparing preamble bits, then it follows that there cannot be a matching tag in the ways.

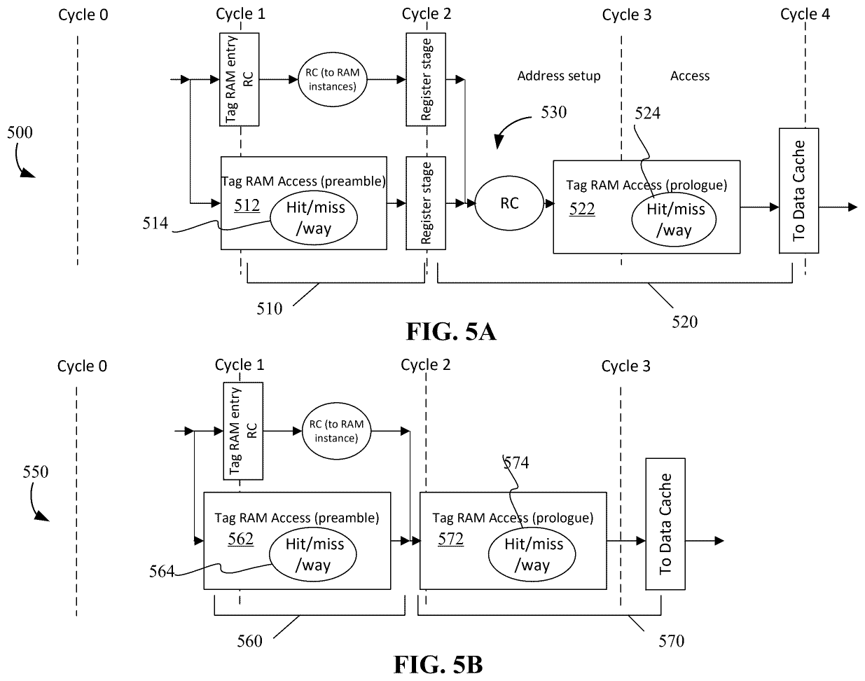

FIGS. 5A and 5B illustrate tag pipelines for a two-phase access as described herein when implemented using a memory incorporating hit logic. In FIG. 5A, a pipeline for a relatively larger memory is shown and in FIG. 5B, a pipeline for a relatively smaller memory is shown. The larger memory can be, for example, a system level cache. The smaller memory can be, for example, an L3 cache. In the larger memory, additional delay can be included as part of a stage (or given its own stage) to enable sufficient time for data to reach the farthest memories after the partial hit logic takes place.

Referring to FIG. 5A, a tag pipeline 500 includes in a first RAM stage 510 (which may include an address setup stage and an access stage), accessing (512) a preamble tag RAM and performing (514) a hit/miss operation on preamble bits of a plurality of ways stored in the preamble tag RAM (e.g., comparing received preamble bits with stored preamble bits of ways in the preamble tag RAM); and in a second RAM stage 520 (which may also include an address setup stage and an access stage), for any ways having a hit on the preamble bits, accessing (522) corresponding way RAMs and performing (524) a corresponding hit/miss operation on prologue bits stored in the corresponding way RAMs (e.g., comparing received prologue bits with stored prologue bits of ways in the corresponding way RAM(s)). The first RAM stage 510 (which includes the clock cycle inside the RAM) can be without a delay stage before it for sending signals to the farthest tag RAMs (e.g., such as delay stage 122 of FIG. 1B).

At the beginning/ending of each stage, the data can be held for a short time in a register. In some cases, extra delay 530 in the form of additional time within the second RAM stage 520 (e.g., during the cycle for address setup) can be provided to enable sufficient time for data to reach the farthest memories after the partial hit logic takes place. Here, it is possible to include the extra delay 530 within the second RAM stage 520 because less time is needed to cover distance (e.g., due to the filtering of accesses to ways containing bits of the tag for the second part of the tag lookup by inhibiting access to memory storing the ways that mismatch/are found to be a miss as a result of the hit/miss operation that occurs in the first stage). Of course, it is possible to include the extra delay as an additional stage between the first RAM stage 510 and the second RAM stage 520. In some cases, in the first RAM stage 510, the data (e.g., of address 110) can be sent across the wires to the way RAMs in advance of accessing any particular way RAM storing a way indicated by a partial hit from the preamble tag RAM hit/miss operation.

Referring to FIG. 5B, tag pipeline 550 similarly includes in a first RAM stage 560 (which may include an address setup stage and an access stage), accessing (562) a preamble tag RAM and performing (564) a hit/miss operation on preamble bits of a plurality of ways stored in the preamble tag RAM (e.g., comparing received preamble bits with stored preamble bits of ways in the preamble tag RAM); and in a second RAM stage 570 (which may also include an address setup stage and an access stage), for any ways having a hit on the preamble bits, accessing (572) corresponding way RAMs and performing (574) a corresponding hit/miss operation on prologue bits stored in the corresponding way RAMs (e.g., comparing received prologue bits with stored prologue bits of ways in the corresponding way RAM(s)). In some cases, in the first RAM stage 560, the data (e.g., of address 110) can be sent across the wires to the way RAMs in advance of accessing any particular way RAM storing a way indicated by a partial hit from the preamble tag RAM hit/miss operation. As can be seen, the first RAM stage 560 can be a stage without a delay stage before it for sending signals to the farthest tag RAMs (e.g., such as delay stage 122 of FIG. 1B).

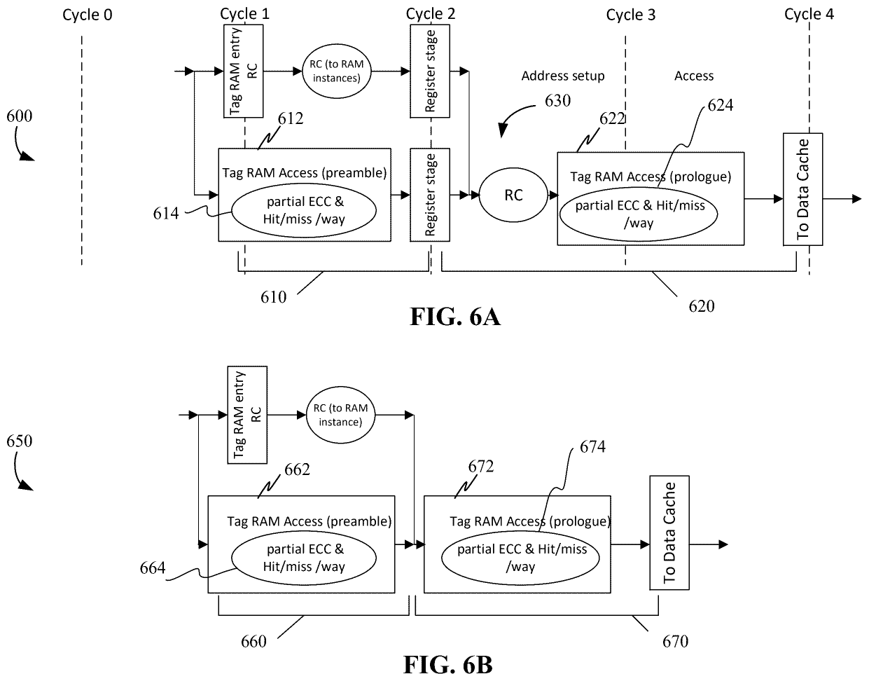

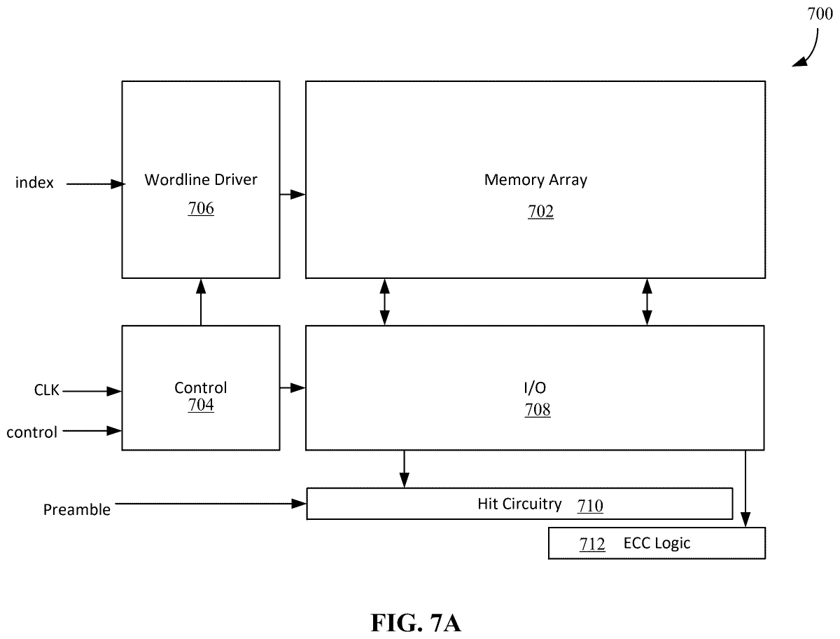

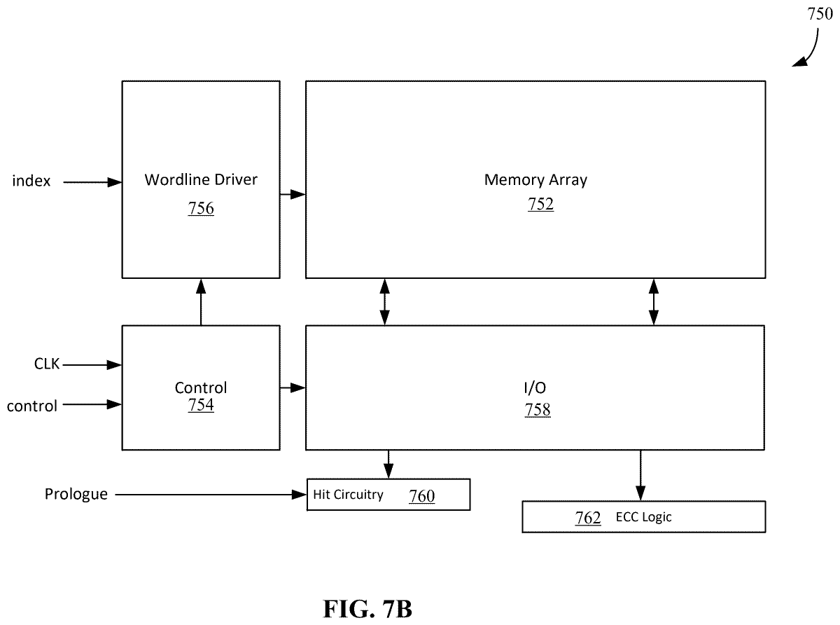

FIGS. 6A and 6B illustrate tag pipelines for a two-phase access as described herein when implemented using a memory incorporating hit logic and part of an error correction code circuitry. The memory incorporating hit logic and part of an error correction code circuitry can be implemented such as described with respect to FIGS. 7A and 7B. In FIG. 6A, a pipeline for a relatively larger memory is shown; and in FIG. 6B, a pipeline for a relatively smaller memory is shown. In the larger memory, additional delay can be included as part of a stage (or given its own stage) to enable sufficient time for data to reach the farthest memories after the partial hit logic takes place. In some cases, only the preamble tag RAM includes ECC logic while the prologue tag RAM does not include the ECC logic. In some of such cases, ECC may be performed outside of the RAM (or even omitted entirely).

Referring to FIG. 6A, a tag pipeline 600 includes in a first RAM stage 610 (which may include an address setup stage and an access stage), accessing (612) a preamble tag RAM and performing (614) both a hit/miss operation on preamble bits of a plurality of ways stored in the preamble tag RAM (e.g., comparing received preamble bits with stored preamble bits of ways in the preamble tag RAM) and a partial error correction code operation; and in a second RAM stage 620 (which may also include an address setup stage and an access stage), for any ways having a hit on the preamble bits, accessing (622) corresponding way RAMs and performing (624) both a corresponding hit/miss operation on prologue bits stored in the corresponding way RAMs (e.g., comparing received prologue bits with stored prologue bits of ways in the corresponding way RAM(s)) and a partial error correction code operation. At the beginning/ending of each stage, the data can be held for a short time in a register.

In some cases, extra delay 630 in the form of additional time within the second RAM stage 620 can be provided to enable sufficient time for data to reach the farthest memories after the partial hit logic takes place. Of course, it is possible to include the extra delay as an additional stage between the first RAM stage 610 and the second RAM stage 620. In some cases, in the first RAM stage 610, the incoming address (e.g., address 110) can be sent across the wires to the way RAMs in advance of accessing any particular way RAM storing a way indicated by a partial hit from the preamble tag RAM hit/miss operation. As can be seen, the first RAM stage 610 (which includes the clock cycle inside the RAM) can be without a delay stage before it for sending signals to the farthest tag RAMs (e.g., such as delay stage 122 of FIG. 1B).

Referring to FIG. 6B, tag pipeline 650 similarly includes, in a first RAM stage 660, accessing (662) a preamble tag RAM and performing (664) both a hit/miss operation on preamble bits of a plurality of ways stored in the preamble tag RAM (e.g., comparing received preamble bits with stored preamble bits of ways in the preamble tag RAM) and a partial error correction code operation; and in a second RAM stage 670, for any ways having a hit on the preamble bits, accessing (672) corresponding way RAMs and performing (674) both a corresponding hit/miss operation on prologue bits stored in the corresponding way RAMs (e.g., comparing received prologue bits with stored prologue bits of ways in the corresponding way RAM(s)) and a partial error correction code operation. In some cases, in the first RAM stage 660, the incoming address (e.g., address 110) can be sent across the wires to the way RAMs in advance of accessing any particular way RAM storing a way indicated by a partial hit from the preamble tag RAM hit/miss operation.

As can be seen, the first RAM stage 660 can be without a delay stage before it for sending signals to the farthest tag RAMs (e.g., such as delay stage 122 of FIG. 1B).

By using the memory incorporating some of the logic for carrying out hit/miss operations, it is possible to reduce the timing (e.g., shorten the clock cycle and/or decrease latency by removing the need for extra clock cycles) of the stages of the pipelines. In addition, as can be seen by comparing the pipeline of FIG. 1B to the pipeline 500 of FIG. 5A and the pipeline 600 of FIG. 6A, it is possible to obtain hit or miss information (based on a partial hit/miss) two stages before the conventional pipeline of FIG. 1B (e.g., in the two cycles for RAM access compared to the four due to delay to RAM instances, RAM access, and hit/miss operation).

FIG. 7A illustrates a representational diagram of a memory circuitry that can be used in a first stage of tag way-halting as described herein. Referring to FIG. 7A, memory circuitry 700 includes a memory array 702, a control circuit 704, wordline driver 706, input/output circuitry 708, hit circuitry 710, and, in some cases, part of an error correction code circuitry (ECC logic 712). The memory circuitry 700 can be used in a first stage of a pipeline such as pipeline 500 of FIG. 5A, pipeline 550 of FIG. 5B, pipeline 600 of FIG. 6A, and pipeline 650 of FIG. 6B.

The memory array 702 is structured in an array of bitcells with rows accessed by wordlines and columns accessed by bitlines. Each bitcell refers to the memory element storing a single bit of information. In certain implementations, memory array 702 is SRAM. The control circuit 704 provides control signals for operations of the memory circuitry 700. The wordline driver 706 receives an address (e.g., the index bits) and turns on a wordline indicated by the index bits in response to receiving a signal from the control circuit 704. The input/output circuitry 708 contains the read circuitry and write circuitry that utilize bitlines to read and write data out of and into the memory array 702. The hit circuitry 710 supports the determination of a hit/miss of the tag bits within the memory circuitry 700 and the ECC logic 712 supports certain parts of error correction processes within the memory circuitry 700.

FIG. 7B illustrates a representational diagram of a memory circuitry that can be used in a second stage of tag way-halting as described herein. Referring to FIG. 7B, memory circuitry 750 includes a memory array 752, a control circuit 754, wordline driver 756, input/output circuitry 758, hit circuitry 760, and, in some cases, part of an error correction code circuitry (ECC logic 762). The memory circuitry 750 can be used in a second stage of a pipeline such as pipeline 500 of FIG. 5A, pipeline 550 of FIG. 5B, pipeline 600 of FIG. 6A, and pipeline 650 of FIG. 6B.

Memory array 752, control circuit 754, wordline driver 756, and input/output circuitry 758 can be implemented such as described with respect to memory array 702, control circuit 704, wordline driver 706, and input/output circuitry 708 of FIG. 7A. The hit circuitry 760 supports the determination of a hit/miss of the tag bits for a way. Since the memory circuitry 750 can be used as prologue tag memory, fewer columns of the memory array 752 are coupled to hit circuitry 760. ECC logic 762 supports certain parts of error correction processes within the memory circuitry 750.

In some cases, the second stage can be performed starting in a clock cycle immediately following completion of the first RAM stage. In other cases, the second stage can be performed in a subsequent clock cycle to the completion of the first RAM stage, but not necessarily the clock cycle immediately following the first RAM stage.

As can be seen, it is possible to determine that there is no hit in the first stage, thereby reducing power consumption and improving speed. It is further possible to obtain a hit for a way in fewer cycles than in a conventional pipeline such as shown in FIG. 1B (e.g., 2 cycles as compared to 4 cycles). Even when a same number of cycles are used (e.g., incorporating an extra stage for delay 530 or 630 and/or using different memory), the amount of time/operational frequency for the clock can be reduced as compared to the conventional pipeline.

Accordingly, by incorporating additional logic within the RAM used for a Way Halting Cache, it is possible to minimize the timing delays caused by the slow speed of current memories as compared to the increased operational speed of logic circuitry when having to first read out all of the bits in the RAM before performing logic operations to complete a lookup operation in the Way Halting Cache. Furthermore, by reducing the number of RAMs being accessed additional power savings can be achieved. In addition, by placement of the preamble RAM physically closer to control logic, it is possible to increase speed and provide further power savings from the interconnecting wires.

FIG. 8A illustrates an example of data that may be stored in a preamble tag memory; and FIG. 8B illustrates an example of data that may be stored in a prologue tag memory. Referring to FIG. 8A, data within a preamble tag memory 800 can include the preamble bits 810 from a plurality of ways (and may include the preamble bits from all available ways). In the example, preamble bits of a 16-way cache are shown. Here, four bits of the tag (b0, b1, b2, b3) are stored as the preamble for each way (Way0, Way1, . . . , Way15) in a row of the memory. In addition, ECC bits 820 are stored, covering the preamble bits of all sixteen ways in a row. In such a case, 6 ECC bits may be used as an example. For example, for row 830, preamble bits 810-A of Way0, preamble bits 810-B of Way1, all the way to preamble bits 810-0 of Way15 are stored and 6 ECC bits cover the row 830. In some cases, other data may be stored in the preamble tag memory 800.

Referring to FIG. 8B, data within a prologue tag memory 850 can include the prologue bits 860, memory data information 870, and ECC bits 880 for each row (e.g., row 490). In some cases, there can be more than one way in the prologue tag memory 850. In such cases, the ECC bits can be provided per way or can be provided for the entire row (even when data of more than one way is in the row). In the example, 9 prologue bits (based on 4 preamble bits of a 13-bit tag being in a preamble tag RAM), 22 bits of the remaining address information, and corresponding ECC bits are stored in each entry. Six ECC bits may be used as an example. In some cases, other data may be stored in the prologue tag memory 850.

As illustrated in FIGS. 8A and 8B, for the addresses available in the cache (as opposed to only being found in main memory), the preamble bits 810 of the tag portion of addresses and some ECC bits are stored in preamble tag memory 800; and the rest of the bits for the addresses can be stored in the prologue tag memory 850 with the prologue bits 860 of the tag portion (and ECC bits 880 for the way or row). As part of the logical model of an address, the address includes a tag portion, a set portion, and a data portion. The tag portion contains the tag bits and is used to check against the tag bits stored in the tag RAMs. The set portion includes address bits (“index portion”), which can be used to access appropriate cells in memory (e.g., as an index for wordline/row selection). The data portion can include various information bits. The information bits in a stored data portion can include error correction code (ECC) bits, valid bit (e.g., whether the data is valid/meaningful), and security bits, as some examples. In some current technologies, the tag portion includes 13 bits and the set portion includes 13 bits. The number of bits in the data portion is dependent on the size of the cacheline (and can be considered sub-cacheline address bits).

It should be understood that for the examples shown in FIGS. 8A and 8B, the distribution of tag bits into the preamble and prologue is for illustrative purposes only. Selection of the number of bits to be preamble bits can be based on optimizations for energy consumption and area as some examples. In some cases, the LSBs (least significant bits) of a tag portion of an address are used for the preamble as these are the most likely bits to change in value. In addition, the address can be hashed to improve entropy.

Certain embodiments of the illustrated methods and circuitry include the following.

Clause 1. A method of memory access, comprising: in a first stage, accessing a preamble tag memory and performing a comparison between received preamble bits of an address for lookup and preamble bits stored in the preamble tag memory to generate a partial hit, wherein the preamble tag memory is a memory for storing preamble bits of tags; and in a second stage, for any partial hits on the preamble bits, accessing one or more prologue tag memories storing prologue bits corresponding to a second set of bits of the tags to which the preamble bits generated the partial hit in the first stage and performing a corresponding comparison between received prologue bits of the address for lookup and the prologue bits stored in the prologue tag memory to finalize a hit.

Clause 2. The method of clause 1, wherein the preamble tag memory stores preamble bits of a plurality of ways, wherein the prologue tag memory stores associated prologue bits of one or more of the plurality of ways.

Clause 3. The method of clause 2, wherein all prologue tag memories storing the prologue bits corresponding to the second set of bits of the tags to which the preamble bits generated the partial hit in the first stage are accessed in the second stage.

Clause 4. The method of any preceding clause, wherein the comparison between received preamble bits of the address for lookup and the preamble bits stored in the preamble tag memory is performed by hit circuitry in the preamble tag memory.

Clause 5. The method of any preceding clause, wherein the comparison between received prologue bits of the address for lookup and the prologue bits stored in the prologue tag memory is performed by hit circuitry in the prologue tag memory.

Clause 6. The method of any preceding clause, wherein the first stage is part of a two-cycle memory access and the second stage is part of a two-cycle memory access that begins sequentially after the first stage is complete.

Clause 7. The method of any preceding clause, further comprising a delay stage between the first stage and the second stage. 8. The method of claim 1, wherein the method is performed to access system level cache.

Clause 9. The method of any preceding clause, further comprising performing a first partial error correction code (ECC) operation in the first stage.

Clause 10. The method of clause 9, wherein performing the first partial ECC operation is performed by ECC logic in the preamble tag memory.

Clause 11. The method of any preceding clause, further comprising performing a second partial error correction code (ECC) operation in the second stage.

Clause 12. The method of clause 11, wherein performing the second partial ECC operation is performed by ECC logic in the prologue tag memory.

Clause 13. A system comprising: a memory subsystem comprising a preamble tag memory and one or more prologue tag memories, wherein the preamble tag memory stores preamble bits of tags, wherein the one or more prologue tag memories store prologue bits corresponding to a second set of bits of the tags and memory data information, wherein the preamble tag memory and the one or more prologue tag memories each include a memory array, control circuit, wordline driver, and input/output circuitry, and wherein access to the one or more prologue tag memories is based on a partial hit of a received address on preamble bits stored in the preamble tag memory.

Clause 14. The system of clause 13, wherein the memory subsystem comprises multiple preamble tag memories and corresponding one or more prologue tag memories.

Clause 15. The system of clause 13 or 14, wherein the preamble tag memory and the one or more prologue tag memories each further include hit circuitry.

Clause 16. The system of any of clauses 13-15, wherein the preamble tag memory and the one or more prologue tag memories each further include error correction code (ECC) logic for a partial ECC operation.

Clause 17. The system of any of clauses 13-16, wherein the cache is a system level cache.

Clause 18. The system of any of clauses 13-17, wherein the preamble tag memory stores the preamble bits of tags of a plurality of ways.

Clause 19. The system of clause 18, wherein each prologue tag memory of the one or more prologue tag memories stores the prologue bits and memory data information of one or more of the plurality of ways.

Clause 20. The system of any of clauses 13-19, wherein the preamble tag memory is located closer to control logic of the cache than the one or more prologue tag memories.

Although the subject matter has been described in language specific to structural features and/or acts, it is to be understood that the subject matter defined in the appended claims is not necessarily limited to the specific features or acts described above. Rather, the specific features and acts described above are disclosed as examples, implementing the claims and other equivalent features and acts; they are intended to be within the scope of the claims.

What is claimed is:

1. A method of memory access, comprising:
in a first stage, accessing a preamble tag memory and performing a comparison between received preamble bits of an address for lookup and preamble bits stored in the preamble tag memory to generate a partial hit, wherein the preamble tag memory is a memory for storing preamble bits of tags; and
in a second stage, for any partial hits on the preamble bits, accessing one or more prologue tag memories storing prologue bits corresponding to a second set of bits of the tags to which the preamble bits generated the partial hit in the first stage and performing a corresponding comparison between received prologue bits of the address for lookup and the prologue bits stored in the prologue tag memory to finalize a hit.

2. The method of claim 1, wherein the preamble tag memory stores preamble bits of a plurality of ways, wherein the prologue tag memory stores associated prologue bits of one or more of the plurality of ways.

3. The method of claim 2, wherein all prologue tag memories storing the prologue bits corresponding to the second set of bits of the tags to which the preamble bits generated the partial hit in the first stage are accessed in the second stage.

4. The method of claim 1, wherein the comparison between received preamble bits of the address for lookup and the preamble bits stored in the preamble tag memory is performed by hit circuitry in the preamble tag memory.

5. The method of claim 1, wherein the comparison between received prologue bits of the address for lookup and the prologue bits stored in the prologue tag memory is performed by hit circuitry in the prologue tag memory.

6. The method of claim 1, wherein the first stage is part of a two-cycle memory access and the second stage is part of a two-cycle memory access that begins sequentially after the first stage is complete.

7. The method of claim 1, further comprising a delay stage between the first stage and the second stage.

8. The method of claim 1, wherein the method is performed to access system level cache.

9. The method of claim 1, further comprising performing a first partial error correction code (ECC) operation in the first stage.

10. The method of claim 9, wherein performing the first partial ECC operation is performed by ECC logic in the preamble tag memory.

11. The method of claim 1, further comprising performing a second partial error correction code (ECC) operation in the second stage.

12. The method of claim 11, wherein performing the second partial ECC operation is performed by ECC logic in the prologue tag memory.

13. A system comprising:
a memory subsystem comprising a preamble tag memory and one or more prologue tag memories,
wherein the preamble tag memory stores preamble bits of tags,
wherein the one or more prologue tag memories store prologue bits corresponding to a second set of bits of the tags and memory data information,
wherein the preamble tag memory and the one or more prologue tag memories each include a memory array, control circuit, wordline driver, and input/output circuitry, and
wherein access to the one or more prologue tag memories is based on a partial hit of a received address on preamble bits stored in the preamble tag memory.

14. The system of claim 13, wherein the memory subsystem comprises multiple preamble tag memories and corresponding one or more prologue tag memories.

15. The system of claim 13, wherein the preamble tag memory and the one or more prologue tag memories each further include hit circuitry.

16. The system of claim 15, wherein the preamble tag memory and the one or more prologue tag memories each further include error correction code (ECC) logic for a partial ECC operation.

17. The system of claim 13, wherein the memory subsystem is a system level cache.

18. The system of claim 13, wherein the preamble tag memory stores the preamble bits of tags of a plurality of ways.

19. The system of claim 18, wherein each prologue tag memory of the one or more prologue tag memories stores the prologue bits and memory data information of one or more of the plurality of ways.

20. The system of claim 13, wherein the preamble tag memory is located closer to control logic of the memory subsystem than the one or more prologue tag memories.
